(19) United States
(12) Patent Application Publication
(10) Pub. No.: US 2010/0301231 A1
(43) Pub. Date: Dec. 2, 2010

(54) APPARATUS, METHOD AND COMPUTER PROGRAM FOR FLUORESCENCE CORRELATION SPECTROSCOPY

(75) Inventor: Mitsushiro YAMAGUCHI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/776,657

(22) Filed: May 10, 2010

(30) Foreign Application Priority Data
May 26, 2009 (JP) 2009-126878

(51) Int. Cl. G01J 1/58

(52) U.S. Cl. 250/459.1; 250/458.1

(57) ABSTRACT

There are provided an apparatus, a method and a computer program for fluorescence correlation spectroscopy (FCS), which can reduce the number of times of fluorescence measurements of control samples as few as possible for a measurement by FCS in detecting existence ratios of the respective components contained in a sample. In the inventive apparatus, method and computer program for detecting an existence ratio of each of components with a fluorescent label contained in a solution sample by FCS, using a value of a ratio of a translational diffusion time of each of the components based upon the knowledge that a ratio of a translational diffusion time of each of the components is conservative under different measurement conditions etc.

### TECHNICAL FIELD

This invention relates to a fluorescence analytical apparatus and a fluorescence analytical method using Fluorescence Correlation Spectroscopy (FCS) and a computer program thereof, and more specifically, to an apparatus, a method and a computer program by FCS for conducting detections and analyses of interactions, binding and/or dissociation conditions of various molecules, such as proteins, peptides, nucleic acids, lipids, sugar chains, amino acids and other biological molecules.

### BACKGROUND ART

According to the developments of optical measurement techniques in recent years, Fluorescence correlation spectroscopy (FCS), which enables measurements and analyses of fluorescence at molecular level, has become available (Non-patent documents 1 and 2). In FCS, briefly speaking, by using an optical system of a laser confocal microscope and a super-highly sensitive photon detecting device enabling the photon counting (the single photon detection), the intensity of fluorescence from a fluorescent particle, such as a fluorescent molecule, a fluorescently labeled molecule, passing through a micro area in a solution sample (called a “confocal volume”, a focal area to which a laser beam of the microscope is condensed) is measured, and then an autocorrelation function of the resultant fluorescence intensity is calculated. The autocorrelation function can be considered as an index of fluctuation in a fluorescence intensity from fluorescent particles, and the fluctuation in the fluorescence intensity corresponds to the fluctuation of the number of fluorescent particles in the micro area, and therefore, in the value of the autocorrelation function, an average residence tune of a fluorescent particle (translational diffusion time) and an average residence number of fluorescent particles (average number of particles) in the micro area are reflected. Consequently, the value of this autocorrelation function provides information on motion speeds, sizes and concentrations of fluorescent molecules, etc., and based upon the information, various phenomena, such as a structural or size change of a molecule, a binding and/or dissociation reaction or dispersion and aggregation of molecules, etc. can be detected.

Also, in the fields of biological science, medicine or pharmaceutical science, it has been tried to use the FCS in a detection or an observation of conditions and motions of biological molecules etc., for clarifying various phenomena or reactions of biological molecules etc. at a cellular or molecular level (Patent documents 1 and 2, non-patent document 3). For instance, in a reaction of a pair of mutually combinable molecules (an antigen and an antibody, a DNA and a protein, etc.) with a fluorescent label being attached to at least one of those molecules, a motion and/or a conditional change of the fluorescent label on the at least one molecule is reflected in fluctuation in the fluorescence intensity from the fluorescence label, so that an intermolecular binding in proteins, DNA, etc. can be detected. Especially, there has been proposed a model formula which gives an autocorrelation function value of a fluorescence intensity for a condition where plural fluorescent molecular components are entering into and exiting out of a micro area from which fluorescence is observed, and, with that model formula, the existence ratios of plural fluorescent molecular components in a solution sample are determined, and based upon the determined ratio, the computation of a dissociation constant, a binding constant, etc. has become possible (Non-patent document 2). Further, since, in FCS, a measurement is possible with extremely smaller sample volume and in shorter time in comparison with the conventional biochemical methods, its application for clinical diagnoses of various diseases or the screening of bioactive substances is also expected in the fields of medicine, pharmacology, etc.

Patent document 1: Japanese Laid-Open Patent No. 2005-098876
Patent document 2: Japanese Laid-Open Patent No. 2008-292371
Non-patent document 1: Masataka Kaneshiro, Protein, Nucleic acid Enzyme Vol. 44, No. 9, p. 1431-1438 (1999)
Non-patent document 2: F. J. Meyer-Alms, Fluorescence Correlation Spectroscopy, R. Rigler, edit. Springer, Berlin, 2000, p. 204-224
Non-patent document 3: Noriko Kato, et. al. Gene Medicine, Vol. 6, No. 2, p. 271-277.

### SUMMARY OF THE INVENTION

In detecting an existence ratio (the ratio of the number of molecules) of each component in a sample containing coexistent molecular components of plural kinds by the above mentioned fluorescence correlation spectroscopy, for instance, in order to perform a detection of an intermolecular binding ratio of at least two components or a detection of the degree of progress of a reaction with a change of molecular weight, etc., typically, there are performed first a measurement of fluorescence intensity for a sample to be tested and the calculation of an autocorrelation function, and subsequently, the fitting process of the following formula to the computed autocorrelation function C (τ) is performed to determine the existence ratio yi of each of the components,

$$C ( τ ) = 1 + \frac{1}{N} {\sum }_{i} {yi ( 1 + \frac{τ}{{τ}_{i}} )}^{- 1} {( 1 + \frac{τ}{{AR}^{2} {τ}_{i}} )}^{- 1 / 2} , \qquad ( 1 )$$

where N is an average number of fluorescent particles existing in a confocal volume; AR is a ratio of the longitudinal length wz and the lateral radius wo of the confocal volume (AR=wz/wo), called as Structure parameter (see FIG. 1(B)); and n is a translational diffusion time of each component. Thus, for determining the existence ratios of the respective components through the fitting of an autocorrelation function in accordance with the formula (I), it is preferable that the structure parameter AR and the translational diffusion time values τi of the respective components are determined in advance (Since N is given by C (0), it is given by the fitting.). In this connection, the values of the structure parameter AR and translational diffusion times τi can vary depending upon measurement conditions or adjusted conditions of the apparatus. Thus, in usual, for performing a measurement in good precision, at every time in measuring fluorescence intensity of a test sample (sample to be tested), there are performed the measurement of fluorescence intensity and the calculation of an autocorrelation function thereof for a sample of the fluorescent label (usually a fluorescent dye) attached with a component in the test sample to determine the structure parameter AR from the value of the computed autocorrelation function; and also the measurement of fluorescence intensity and the calculation of an autocorrelation function thereof for a sample containing solely each of the components in the test sample to compute out a translational diffusion time of each of the components. (Hereafter, a sample in which each component contained in the test sample solely exists is called as “control sample”.) For example, in a case of a binding reaction of certain fluorescent molecules to other molecules, a sample with all of the certain fluorescent molecules having bound to the other molecules; and a sample with all of the certain fluorescent molecules having been dissociated from the other molecules each are prepared, and their fluorescence measurements and the calculation of autocorrelation functions and translational diffusion time values are individually performed whenever the fluorescence measurement and analysis of a test sample are performed.

However, it requires longer time and much effort to perform the fluorescence measurements and autocorrelation function calculations of a sample of a fluorescent label and control samples at every time in performing a fluorescence intensity measurement for a test sample. Although the acquisition and/or preparation of a sample of a fluorescent label attached to a component in a test sample are relatively easy (in usual, a sufficient amount of a fluorescent label is prepared in advance.), a control sample may often be expensive or rare and also its preparation may require some efforts, and therefore, it is preferable that the number of times of the fluorescence measurements of such control samples is as few as possible.

Accordingly, one of objects of the present invention is to provide a fluorescence correlation spectroscopic apparatus and/or method, or computer programs thereof, which can lessen the number of times of fluorescence measurements of control samples as few as possible in a measurement by FCS for detecting an existence ratio of each component in a sample containing coexistent components of plural kinds.

In this regard, according to the study of the inventor of the present invention, it has been experimentally confirmed that, while the absolute value of a translational diffusion time of each component in arbitrary plural components varies with conditions in measurements and adjustments of an apparatus, the ratio of translational diffusion time values of the plural components detected under the same measurement condition and the same adjusted condition of an apparatus is almost constantly maintained even under different measurement conditions and/or different adjusted conditions of apparatus. Thus, employing this knowledge, the present invention is proposed to achieve the above mentioned object.

In one of the aspects of the present invention, there is provided a fluorescence correlation spectroscopic apparatus adapted to be capable of detecting an existence ratio of each of components of at least two kinds with a fluorescent label contained in a solution sample, which apparatus comprises a data storage region which memorizes a value of a ratio of a translational diffusion time of each of the components of at least two kinds; and a detecting portion that detects the existence ratio of each of the components of at least two kinds from an autocorrelation function value of a fluorescence intensity measured with the solution sample, using the memorized value of the ratio of the translational diffusion time of each of the components of at least two kinds.

As already noted, a translational diffusion time value of an arbitrary molecule or particle varies depending upon measurement conditions in the fluorescence measurement, such as a temperature, the viscosity of a solution, and adjusted conditions of an apparatus, especially, the dimensions of a confocal volume, which vary depending upon the condensing condition of a laser light beam, the thickness of a cover glass of a container of a solution, etc. However, according to experiments by the inventor of the present invention, it has been confirmed that the ratios of translational diffusion time values of molecules or molecular assemblies of arbitrary plural kinds are almost constant (conservative) irrespective of measurement conditions and adjusted conditions of apparatus. Thus, in the present invention, a value of a ratio of a translational diffusion time of each of components of at least two kinds contained in a solution sample has been prepared or memorized in the apparatus in advance, and then, the existence ratio of each of the components of at least two kinds in the solution sample is detected from an autocorrelation function value of a fluorescence intensity measured with the solution sample with reference to the values of the translational diffusion time ratios. According to this structure, it becomes possible to omit detections of the translational diffusion time values of the control samples, namely, detections of the translational diffusion time values of the respective components of at least two kinds in the solution sample which have been performed whenever the measurement condition or the adjustment of the apparatus has been changed, and thereby the burdens for preparations, measurements, analyses of the control samples can be significantly reduced. In this connection, typically, the value of the translational diffusion time ratio of each of the components of at least two kinds may be a value of a ratio of the translational diffusion time of each of the components of at least two kinds to a translational diffusion time of a reference material with the fluorescent label which is attached to the components (Typically, the reference material with the fluorescent label may be a fluorescent dye molecule itself, but not limited thereto.). In this case, the absolute value of the translational diffusion time of each of the components of at least two kinds is given by multiplying the translational diffusion time of the reference material by the value of the ratio of the translational diffusion time of each of the components of at least two kinds. As for the structure parameter of the apparatus, this value may be determined from an autocorrelation function value of a fluorescence intensity measured with the reference material whenever the measurement condition and/or the adjusted condition of the apparatus are changed, and then memorized in the apparatus.

In the structure of the above mentioned inventive apparatus, the value of the translational diffusion time ratio of each of the components of at least two kinds may be computed out from a translational diffusion time of each of the components of at least two kinds determined from an autocorrelation function value of a fluorescence intensity measured with each of the components of at least two kinds, and then memorized in the above mentioned data storage region. In this respect, once determined values of ratios of translational diffusion times of respective components of at least two kinds are conservative under different measurement conditions and/or different adjusted conditions of the apparatus, and therefore, at least one time of the performing of the fluorescence measurement, computation of an autocorrelation function and computation of a translational diffusion time in a sufficient accuracy under the identical measurement condition and apparatus's adjusted condition for each of the components is enough, and thereby the time and effort which would be required in the prior art will be reduced significantly. Thus, the inventive apparatus may further comprise a portion that determines a translational diffusion time of each of the components of at least two kinds from an autocorrelation function value of a fluorescence intensity measured for each of the components of at least two kinds; a portion that computes the value of the ratio of the translational diffusion time of each of the components of at least two kinds; and a portion that memorizes in the data storage region the value of the ratio of the translational diffusion time of each of the components of at least two kinds. Further, since values of translational diffusion time ratios of respective components of at least two kinds are conserved under various measurement conditions and apparatus' adjusted conditions, the values to be memorized in the data storage region as translational diffusion time ratios of the respective components of at least two kinds may be values which have been experimentally or theoretically predetermined not in the same apparatus but in a different apparatus. Thus, the inventive apparatus may also comprises a portion that memorizes in the data storage region a predetermined value of the ratio of the translational diffusion time of each of the components of at least two kinds.

In one embodiment of the inventive apparatus, the existence ratio of each of the components of at least two kinds in the solution sample to be tested may be detected by fitting a theoretical formula of an autocorrelation function to an autocorrelation function value of the fluorescence intensity measured with the solution sample containing the components of at least two kinds. The theoretical formula includes, as its parameter, the value of the translational diffusion time ratio of each of the components of at least two kinds, where a value obtained by multiplying the value of the ratio of the translational diffusion time of each of the components of at least two kinds by a translational diffusion time of the reference material with the fluorescent label may be used as the translational diffusion time of each of the components of at least two kinds.

Moreover, in the above mentioned fitting, the translational diffusion time of each of the components of at least two kinds is not a detected value but an estimated value, and thereby, the precision of the fitting can be reduced. Thus, the inventive apparatus may be designed to comprise a portion that generates a warning that the precision in the fitting is insufficient when a chi square value in the fitting exceeds a predetermined threshold value, so that a detected result with a low fitting precision can be omitted. Further, since the precision of the fitting will vary depending upon an excitation wave length and detected fluorescence wave length (because the degree of the condensation of a laser light beam and the sensitivity of a photodetector may change in accordance with wave lengths.), it is preferable that different predetermined threshold values can be set out for different reference materials.

The feature of using a “translational diffusion time ratio” of each of components of at least two kinds in the above mentioned inventive apparatus can be realized in a general computer. Therefore, in accordance with the present invention, there is provided a computer program product having a computer readable medium including a program for detecting an existence ratio of each of components of at least two kinds with a fluorescent label contained in a solution sample by fluorescence correlation spectroscopy, wherein a program, when executed by a computer, makes the computer perform (a) detecting the existence ratio of each of the components of at least two kinds from an autocorrelation function value of a fluorescence intensity measured with the solution sample, using a value of a ratio of a translational diffusion time of each of the components of at least two kinds memorized in a data storage region.

Also in this computer program, the value of the translational diffusion time ratio of each of the components of at least two kinds may be a value of a ratio of the translational diffusion time of each of the components of at least two kinds to a translational diffusion time of a reference material with the fluorescent label. Further, the existence ratio of each of the components of at least two kinds in the solution sample to be tested may be detected from the autocorrelation function value of the fluorescence intensity measured with the solution sample containing the components of at least two kinds by fitting a theoretical formula of an autocorrelation function, including the values of the translational diffusion time ratios of the respective components of at least two kinds as parameters, to the autocorrelation function value of the fluorescence intensity, and in the theoretical formula, a value obtained by multiplying the translational diffusion time of the reference material with the fluorescent label by the value of the ratio of the translational diffusion time of each of the components of at least two kinds may be used as the translational diffusion time of each of the components of at least two kinds. Moreover, in the above mentioned inventive computer program product, the program may also be designed to make the computer execute (b) determining the translational diffusion time of each of the components of at least two kinds from an autocorrelation function value of a fluorescence intensity measured with each of the components of at least two kinds; (c) computing the value of the ratio of the translational diffusion time of each of the components of at least two kinds; and (d) memorizing in the data storage region the value of the ratio of the translational diffusion time of each of the components of at least two kinds; or to make the computer execute (e) memorizing in the data storage region a predetermined value of the ratio of the translational diffusion time of each of the components of at least two kinds. Also, the program may also be designed to make a computer execute (f) generating a warning that a precision in the fitting is insufficient when a chi square value in the fitting exceeds a predetermined threshold value.

Further, according to the above mentioned inventive apparatus or computer program, there is provided a method of determining an existence ratio of each of fluorescently labeled components of at least two kinds contained in a solution sample through use of a “translational diffusion time ratio” of each of the components of at least two kinds. Accordingly, the inventive method for detecting an existence ratio of each of components of at least two kinds with a fluorescent label contained in a solution sample by fluorescence correlation spectroscopy comprises (a) detecting the existence ratio of each of the components of at least two kinds from an autocorrelation function value of a fluorescence intensity measured with the solution sample, using a value of a ratio of a translational diffusion time of each of the components of at least two kinds memorized in a data storage region.

Also in this method, the value of the translational diffusion time ratio of each of the components of at least two kinds may be a value of a ratio of the translational diffusion time of each of the components of at least two kinds to a translational diffusion time of a reference material with the fluorescent label. Further, the existence ratio of each of the components of at least two kinds may be detected from the autocorrelation function value of the fluorescence intensity measured with the solution sample containing the components of at least two kinds by fitting a theoretical formula of an autocorrelation function, including the values of the translational diffusion time ratios of the respective components of at least two kinds as parameters, to the autocorrelation function value of the fluorescence intensity, and in the theoretical formula, a value obtained by multiplying the value of the translational diffusion time of the reference material with the fluorescent label by the value of the ratio of the translational diffusion time of each of the components of at least two kinds may be used as the translational diffusion time of each of the components of at least two kinds. And, in the above mentioned method, the memorization of the value of the translational diffusion time ratio of each of the components of at least two kinds contained in the solution sample may be performed by memorizing in the data storage region the value of the ratio of the translational diffusion time of each of the components of at least two kinds after determining the translational diffusion time of each of the components of at least two kinds from an autocorrelation function value of fluorescence intensity measured for each of the components of at least two kinds and computing the value of the translational diffusion time ratio of each of the components of at least two kinds (b, c, d); or by (e) memorizing in the data storage region a predetermined value of the ratio of the translational diffusion time of each of the components of at least two kinds.

According to the above mentioned inventive structure, it becomes possible to reduce substantially the number of times of fluorescence measurements, computations of autocorrelation function values and detections of translational diffusion times for control samples. Thus, it becomes unnecessary to prepare control samples at every measurement of fluorescence intensity with a sample to be tested, and thus the time for the measurements will be shortened. Further, in a case of conducting a measurement by means of a micro plate having a plurality of wells to which various samples are dispensed, it becomes unnecessary to use wells for control samples excessively.

Furthermore, in the present invention, a translational diffusion time of each of at least two components in a sample to be tested can be determined based on a ratio of a translational diffusion time obtained from a measurement performed for each of the components in a sufficient accuracy, and therefore, the reliability of a detected result with respect to the sample to be tested is expected to be improved. In FCS, a translational diffusion time is computed by processing fluorescence measurement results statistically, and thus, inherently, there is a rather large dispersion in the results of the computed translational diffusion time. Namely, the reliability of the translational diffusion time values, detected only by a few or limited times of measurements for control samples conducted at every fluorescence measurement for a sample to be tested, would not be always high, and therefore, the detected results of the sample to be tested, obtained with those translational diffusion times, would be less accurate. However, in the present invention, by the use of a ratio of translational diffusion time of each of the control samples having been determined with a sufficient time, it can be achieved to improve the accuracy in the detected results for the sample to be tested.

Other objects and advantages of the present invention will become apparent from the following explanations of the preferable embodiments of the present invention.

### BRIEF EXPLANATIONS OF THE DRAWINGS

FIG. 1A is a schematic view of an internal structure of a fluorescence correlation spectroscopic apparatus according to the present invention. FIG. 1B is a schematic view of a confocal volume (an observation region of a confocal microscope).

FIG. 2 shows graphs indicating schematically autocorrelation functions of fluorescence intensity computed in the inventive fluorescence correlation spectroscopic apparatus (the left drawings), and schematic drawings of molecules in a measured sample (the right drawings). FIGS. 2A, 2B, 2C each shows an autocorrelation function obtained for Control sample 1 of one component contained in a sample to be tested; an autocorrelation function obtained for Control sample 2 of another component contained in the sample to be tested; and an autocorrelation function obtained for the sample to be tested. In the drawings, the arrows indicate a translational diffusion time of each of the components in the sample to be tested (τ1, τ2).

### MODES FOR CARRYING OUT THE INVENTION

In the followings, preferable embodiments in accordance with the present invention are described in detail.

The Structures of the Fluorescence Correlation Spectroscopic Apparatus and Analytical Method

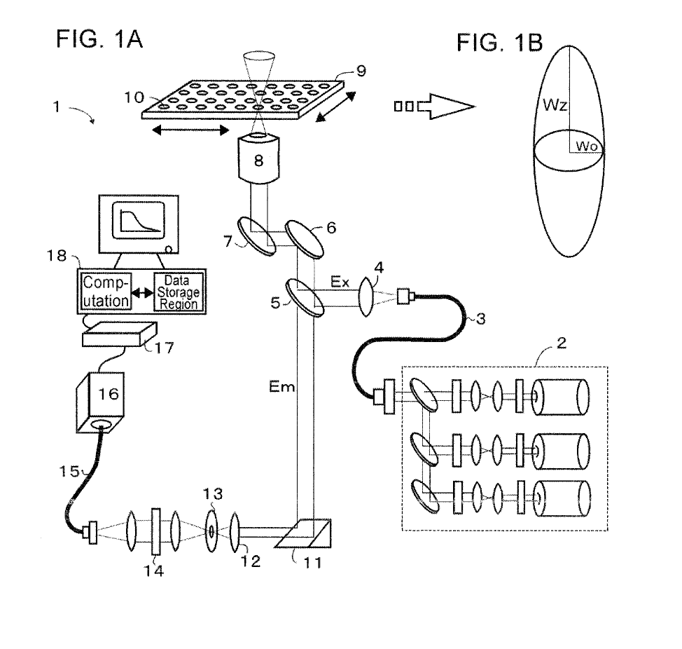

Referring to FIG. 1A, a preferable embodiment of Fluorescence correlation spectroscopic apparatus 1 in accordance with the present invention comprises an optical system 2-17 and a computer 18 which controls the operations of the respective portions in the optical system, and also acquires and analyses data. The optical system of the fluorescence correlation spectroscopic apparatus 1 may be the same as an optical system of a usual confocal microscope. Briefly speaking, first, a laser light (Ex), emitting from a light source 2 and propagating through a single mode fiber 3, is radiated as light diverging from an exit end of the fiber at an angle determined by the NA of the fiber end. This light then forms into a parallel beam with a collimator 4 and reflects on a dichroic mirror 5 and reflective mirrors 6 and 7 to be introduced into an objective 8. Above the objective 8, typically, there is placed a micro plate 9 with plural sample containers or wells 10 arranged thereon, into each of which containers or wells 10, one to several tens of micro liters of a solution sample is dispensed. In the solution sample in one of the sample containers or wells 10, the laser light emitted from the objective 8 focalizes to form a region with a strong light intensity (excitation region). The components (molecules) in the solution sample are provided with a fluorescent label, such as a fluorescent dye etc., and therefore, when these components in the solution sample move to enter into the excitation region by Brownian movement, the fluorescent labels are excited to emit fluorescence until the components move out from the excitation region. Then, the emitted fluorescence (Em) passes through the objective 8 and the dichroic mirror 5; reflects on the mirror 11; converges with a condenser lens 12; and passes through a pinhole 13 to be introduced through a barrier filter 14 (where only the light component in a specific wavelength band region is selected) into a multimode fiber 15. In this regard, as known in one skilled in the art, the pinhole 13 is placed at the conjugate position of the focal position of the objective 8, and thereby only the fluorescence emitted from the focal region, namely the excitation region of the objective 8 as schematically shown in FIG. 1B, can reach to a photodetector 16 and the light from other than the excitation region is intercepted. The focal region of the objective 8 as illustrated by FIG. 1B is called a “confocal volume”, whose volume is usually about 1 femtoliter (fL).

Then, the fluorescence detected with the photodetector 16 is sequentially changed into time series of electric signals and inputted through a controller 17 into the computer 18. In the computer 18, in accordance with programs memorized in a memory apparatus (not shown), the calculation of an autocorrelation function C(τ) of fluorescence intensity I(t) is performed by using the following formula:

$$C ( τ ) = \frac{( \sum I ( t ) \cdot I ( t + τ ) ) / n}{{( \sum I ( t ) )}^{2} / {n}^{2}} \qquad ( 2 )$$

(where, t, τ and n are a measuring time, a correlation time and the number of terms in summation, respectively.), and various analyses are executed. In the analyses, in principle, the fitting of the following formula (3) to the autocorrelation function values of fluorescence is carried out to determine a translational diffusion time τD, i.e., the average residence time of a fluorescence emitting particle entering into the confocal volume, and the average number N of fluorescence emitting particles which reside in the confocal volume:

$$C ( τ ) = 1 + \frac{1}{N} {( 1 + \frac{τ}{{τ}_{D}} )}^{- 1} {( 1 + \frac{τ}{{AR}^{2} {τ}_{D}} )}^{- 1 / 2} , \qquad ( 3 )$$

where AR is a characteristic value indicating the adjusted condition of the apparatus, called a “structure parameter”, which corresponds to the ratio (=wz/wo) of the length wz in the longitudinal direction and the radius we of the confocal volume as illustrated in FIG. 1B. Moreover, in a case that a solution sample contains components of plural kinds (at least two kinds), an existence ratio, yi, of each of the components is determined by fitting the following formula to an autocorrelation function:

$$C ( τ ) = 1 + \frac{1}{N} {\sum }_{i} yi {( 1 + \frac{τ}{{τ}_{i}} )}^{- 1} {( 1 + \frac{τ}{{AR}^{2} {τ}_{i}} )}^{- 1 / 2} , \qquad ( 4 )$$

where τi is the translational diffusion time of each of the components.

In performing the measurement with an arbitrary solution sample using the fluorescence correlation spectroscopic apparatus 1 as described above, in general, several times of fluorescence measurements for about several seconds to several tens of seconds are performed, and for the respective measurements, a translational diffusion time, an average number of particles and/or an existence ratio of each of components is(are) computed out through the calculation of an autocorrelation function and its fitting, and then, the averages of those computed values of the several times are employed as the respective final values.

Furthermore, in performing the measurement with an arbitrary solution sample by fluorescence correlation spectroscopy as described above, typically, the checking of the adjusted condition of the apparatus is performed prior to all the fluorescence measurements. Especially, the dimensions (the radius wo and the longitudinal length wz) of the confocal volume vary depending upon the condensing condition or power of a laser light, a thickness of a cover glass constituting the bottom of a sample container or a well of a micro plate placed above the objective 8, a setting condition of a compensation ring of the objective, the position and/or size of the pinhole 13, etc., and the dimensional variations in the confocal volume affect detected values, such as an autocorrelation function value, a translational diffusion time and an average number of particles. So, in usual, a fluorescence measurement and a calculation of autocorrelation function value is performed with a solution of a reference material including a fluorescent label added to components in a solution sample to be tested (usually, the reference material may be a fluorescent dye molecule itself.), and the structure parameter AR and a translational diffusion time τD of the reference material are determined through the fitting of the formula (3) to the computed autocorrelation function value. And, if the resultant structure parameter value AR falls within a predetermined range, then the adjusted condition of the apparatus is judged to be normal, and the acquired AR is used in the subsequently conducted measurements and analyses (If the adjusted condition of apparatus is not acceptable, the adjustment will be repeated.).

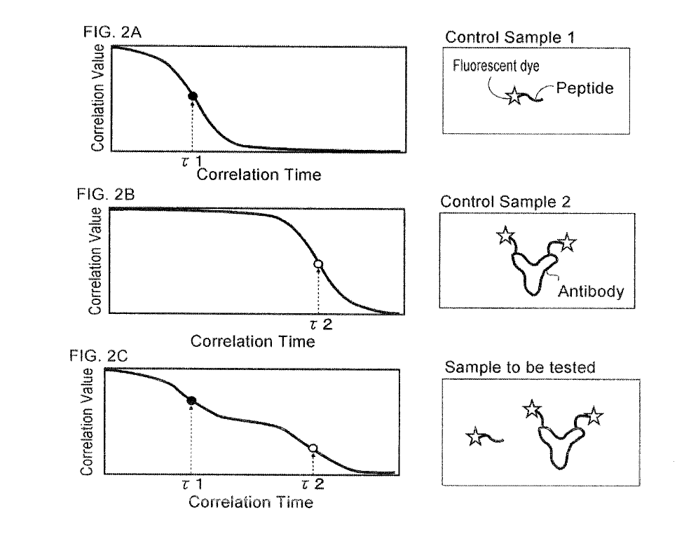

Further, when measurements and analyses for determining an existence, ratio of each of plural components contained in a solution sample are conducted, translational diffusion times τi of the respective components are determined (see FIGS. 2A and 2B). To do this, firstly, a control sample containing only each of the components is prepared, and for each of these control samples, a fluorescence measurement and a calculation of an autocorrelation function value are performed. And subsequently, the translational diffusion time τi of each of the components is computed through the fitting of the formula (3), using the above acquired structure parameter AR as the known quantity, to the autocorrelation function value computed for each of the control samples. Then, the structure parameter AR and the translational diffusion time τi of each of the components are used as the known quantities in the fitting of the formula (4) to an autocorrelation function value of fluorescence of a sample containing components whose existence ratios are to be detected (see FIG. 2C).

In this regard, usually, also fluorescence measurements with a solution of a fluorescent label and control samples for determining a structure parameter AR and translational diffusion times τi of respective components each are perfumed several times, and the averages of ARs and τis, computed from the resultant fluorescence autocorrelation function values, are employed as the respective final values.

Improvements of Fluorescence Correlation Spectroscopy by the Present Invention

As described in the column of “Summary of the Invention”, in a measurement and an analysis of an existence ratio of each of plural components contained in a solution sample by the fluorescence correlation spectroscopy as described above, a structure parameter AR and translational diffusion times τi of the respective components used in the fitting of the formula (4) are parameters varying with the measurement conditions, such as temperature, the viscosity of a solution, etc., and the adjusted conditions of the apparatus, especially, the dimensions of a confocal volume etc. Thus, in the prior art, whenever a measurement and an analysis of a certain sample containing plural components are performed, it is required to prepare a reference material solution and control samples of the respective components in the sample to be tested (For example, when a micro plate 9 with plural wells 10 arranged thereon as illustrated in FIG. 1A is used as a sample container, the reference material solution and control samples of the respective components are to be dispensed to several of the wells.) and the fluorescence measurements and calculations of the autocorrelation functions were performed for the reference material solution and each of the control samples, individually. However, especially, control samples can be often expensive and/or rare, and their preparation can also be cumbersome and/or time consuming. Therefore, in the present invention, the process in the fluorescence correlation spectroscopy is improved as described below, so that the number of times of the fluorescence measurements of control samples can be reduced as few as possible.

(i) The Principle of the Improvement

For a certain component i, its translational diffusion time ti is defined as:

τi=wo²/4Di (5),

where Di is a diffusion constant of the component i. When it is assumed that the component acts as a sphere with a radius ri in a water solution, the diffusion constant is given by:

Di=k_{B}·T/6π·ri·η(T) (6)

[where, k_{B} is Boltzmann constant; T, the absolute temperature of the solution sample; η (T), a coefficient of viscosity of the solution sample which is a function of the temperature T.]
Accordingly, the translational diffusion time τi is given by:

τi=(3π/2k_{B})·wo²·(η(T)/T)·ri (7)

Then, considering the performing of a fluorescence measurement of a solution sample containing plural components, in the formula (7), wo is the dimension of the confocal volume and η(T)/T is an environmental condition at the time of the measurement, and therefore these values are common for all the components in the solution sample. Thus, even when the confocal volume or the environmental conditions at measurements vary, the ratios of the translational diffusion times, τ1:τ2: . . . :τi: . . . , of the components 1, 2, . . . , i, . . . are given by:

τ1:τ2: . . . τi . . . =r1:r2: . . . :ri: . . . (8)

and these ratios are conserved. Therefore, when the translational diffusion time of each component is measured using the corresponding control sample with the same confocal volume and under the same environmental condition and the ratios of the respective components are memorized at least once, the value of the translational diffusion time of each of the components can be estimated without fluorescence measurement and calculation of an autocorrelation function for each of the control samples even if the confocal volume and/or the environmental condition vary during measurements.

(ii) Experiments for the Confirmation of the Principle

In the following experiments, it was confirmed that a translational diffusion time ratio of each of plural components contained in a solution sample is conservative in the fluorescence correlation spectroscopy as described above. In the experiments, fluorescence measurements as described above were performed under different temperature conditions with a solution sample containing solely a fluorescent dye, ATT0633; a solution sample containing solely a peptide with ATT0633 (FIG. 2A, Right); and a solution sample containing solely an antibody bound to the peptide with ATT0633 (FIG. 2B, Right), and then the translational diffusion time of each of the components was computed from an autocorrelation function of the corresponding measured fluorescence intensity. The results are as follows:

TABLE 1
Translational Diffusion Time (microsecond)

| | 1st Trial | 2nd Trial | 3rd time |
|---|---|---|---|
| ATT0633 | 137 | 132 | 128 |
| Peptide with ATT0633 | 290 | 273 | 270 |
| Antibody bound | 880 | 861 | 830 |
| to Peptide | | | |
| with ATT0633 | | | |

From the results, it is seen that the absolute translational diffusion time value of the same sample changes under the different temperature conditions. However, when the resultant values are normalized with the value of the translational diffusion time of ATT0633 of the respective trials, namely, when the ratios of the translational diffusion times are calculated, it was confirmed as shown in Table 2 that the ratio of the translational diffusion time of each of the components was conserved in spite of the variation of the absolute translational diffusion time values.

TABLE 2
The Ratios of Translational Diffusion Time (to Translational
Diffusion Time of AT0633 (Reference material))

| | 1st Trial | 2nd Trial | 3rd Trial |
|---|---|---|---|
| ATT0633 | 1 | 1 | 1 |
| Peptide with ATT0633 | 2.12 | 2.07 | 2.11 |
| Antibody bound | 6.42 | 6.52 | 6.48 |
| to Peptide | | | |
| with ATT0633 | | | |

(iii) The Improvement in the Structures

In the present embodiment, using the knowledge that a ratio of a translational diffusion time of each of plural components contained in a solution sample is conservative in spite of variations in measurement conditions etc., the structures of the method of determining an existence ratio of each of components contained in a solution sample by fluorescence correlation spectroscopy and the fluorescence correlation spectroscopic apparatus 1 used for the method, and a part of the computer program controlling the operation of the apparatus 1 are modified.

In determining an existence ratio of each of plural components contained in a certain solution sample, only when the ratio of the translational diffusion time of each of the components is unknown, a control sample of each of the components is prepared, and the fluorescence measurements, the calculation of autocorrelation functions and the computation of the translational diffusion times through the fitting of the formula (3) are performed for the control samples of the respective components (Prior to the fluorescence measurements of the control samples, a structure parameter AR and the translational diffusion time of a reference material are determined with a solution of the reference material, similarly to the prior art.). Then, the ratio κi of the translational diffusion time of each of the components (to the translational diffusion time of the reference material) is determined by normalizing the computed translational diffusion time of each of the components with the translational diffusion time of the reference material as follows:

κi=τi/τ0 (9)

(τ0 is the translational diffusion time of the reference material.), and the resultant ratios are stored in an arbitrary data storage region. For instance, when a solution sample to be tested contains two components, component 1 and component 2, fluorescently labeled with a reference material 0, the fluorescence measurements are performed with a control sample 1 of the component 1 and a control sample 2 of the component 2, separately, and their autocorrelation functions, as illustrated in FIGS. 2A and 2B, are computed, whereby the translational diffusion times τ1, τ2 are determined, respectively. Then, the translational diffusion time ratios, κ1 and κ2, are determined by:

κ1=τ1/τ0 (10a)

κ2=τ2/τ0 (10b)

, and the resultant values of the ratios are memorized in the data storage region.

In determining the existence ratio of each of the components in the solution sample, a reference material solution and the solution sample to be tested are prepared, and, after determining the structure parameter AR and the translational diffusion time τ0 of the reference material in the current condition, the fluorescence measurement and the computation of the autocorrelation function of the solution sample are performed. Then, the fitting of the formula (11), including the products of the translational diffusion time ratios κi of the respective components and the translational diffusion time τ0 of the reference material as the translational diffusion times of the respective components:

$$C ( τ ) = 1 + \frac{1}{N} {\sum }_{i} yi {( 1 + \frac{τ}{κ i \cdot {τ}_{0}} )}^{- 1} {( 1 + \frac{τ}{{AR}^{2} κ i \cdot {τ}_{0}} )}^{- 1 / 2} \qquad ( 11 )$$

to the autocorrelation function of the solution sample is performed, and thereby, the existence ratio yi of each of the components is determined. For example, when a solution sample to be tested contains component 1 and component 2, fluorescently labeled with a reference material 0, only a solution of the reference material 0 and the solution sample to be tested are prepared, and fluorescence measurements of the reference material 0's solution and the solution sample to be tested are performed. Then, to the autocorrelation function obtained as illustrated in FIG. 2C, the formula (12):

$$C ( τ ) = 1 + \frac{1}{N} [ \begin{matrix}\frac{y 1}{( 1 + \frac{τ}{κ 1 \cdot {τ}_{0}} ) {( 1 + \frac{τ}{{AR}^{2} κ 1 \cdot {τ}_{0}} )}^{1 / 2}} + \\ \frac{1 - y 1}{( 1 + \frac{τ}{κ 2 \cdot {τ}_{0}} ) {( 1 + \frac{τ}{{AR}^{2} κ 2 \cdot τ0} )}^{1 / 2}}\end{matrix} ] \qquad ( 12 )$$

is fit, whereby the existence ratio of the component 1, y1, and the existence ratio of the component 2, y2=1−y1, are determined. In this connection, using the average number of the particles N in the confocal volume, the numbers, N1, N2, of the respective particles of the components 1 and 2 may be given by:

N1=N·y1 (13a)

N2=N·y2 (13b).

Further, when the confocal volume Vc is determined in an arbitrary way, concentrations of the components 1 and 2 are given as:

N·y1/Vc;N·y2/Vc,

, respectively.

In order to achieve a fluorescence correlation spectroscopy as described above, the computer 18 is equipped with a data storage region in which translational diffusion time ratios κi are memorized, as well as structures for determining a translational diffusion time of each of the components of plural kinds from an autocorrelation function value of a fluorescence intensity measured for each of the components; and computing and memorizing the ratios κi. Further, in the computer program for operating the computer 18, there are installed procedures of determining a translational diffusion time of each of the components of plural kinds from an autocorrelation function value of a fluorescence intensity measured for each of the components; and computing and memorizing a ratio κi of a translational diffusion time computed from an autocorrelation function of a control sample and a procedure of executing the fitting of the above mentioned formula (11) or (12) with the translational diffusion time ratios κi memorized in the data storage region.

Moreover, since the translational diffusion time ratios κi of the respective components are conservative under various measurement conditions, etc., the ratios may not be values measured by the same fluorescence correlation spectroscopic apparatus 1. Thus, the fluorescence correlation spectroscopic apparatus 1 and the computer program may be adapted to enable an operator to input, into a data storage region, a ratio κi of a translational diffusion time of each component, independently determined in the exterior of the apparatus 1. A value of a translational diffusion time ratio κi to be inputted may be a value determined by an arbitrary calculation method, such as the molecular dynamics.

(iv) Prevention Against Deterioration of the Fitting Accuracy

In the fitting of the formula (11) or (12) with translational diffusion time ratios κi to an autocorrelation function obtained from a fluorescence measurement as described above, the translational diffusion time of each component is not an actually measured value but an estimated value, and due to this, the fitting accuracy therein may deteriorate. Thus, in the present embodiment, a structure fer enabling an operator to check the accuracy in the fitting of the formula (11) or (12) may be provided. More concretely, in executing the fitting of the formula (11) or (12), there is calculated a chi square value: a characteristics parameter indicating a difference between an actual autocorrelation function value and a fitting function value (Briefly, the chi square value is a total sum of differences between actual autocorrelation function values and fitting function values.). Then, if the chi square value exceeds a predetermined threshold value, a warning indicating that the accuracy in the fitting is insufficient is generated for an operator e.g. by displaying the warning on a monitor. Further, since the degree of condensation of a laser light and the sensitivity of a photodetector in the apparatus vary depending upon the light wave length, whether or not the fitting is successful may depend upon an excitation wave length or a detected fluorescence wave length. So, it is preferable that different predetermined threshold values for the chi square value may be set for different reference materials.

Consequently, in the above mentioned embodiments, the knowledge that a ratio of a translational diffusion time of each of components contained in a solution sample is conserved even if measurement conditions etc. are varied as described above is taken into account, and therefore, in detecting existence ratios of the respective components in an arbitrary solution samples by fluorescence correlation spectroscopy, once the ratio of the translational diffusion time of each of the components is acquired, then the fluorescence measurements and the calculation of an autocorrelation function of a control sample of each of the components can be omitted. This strategy enables the saving of consumed amounts of control samples and the significant reduction of the duration for the measurement and analysis of the control samples, providing the throughput improvement (In a case that the measurement is performed with solution samples being dispensed into a plurality of wells arranged on one micro plate, the number of the wells to which control samples are assigned will be reduced.).

Furthermore, as ratios of translational diffusion times of components in a sample to be tested, it is preferable to employ the ratios of the translational diffusion times of the components to a translational diffusion time of a fluorescent dye molecule (reference material) attached to the components. In this case, a translational diffusion time of an arbitrary component whose ratio to the translational diffusion time of the reference material has been obtained can be determined only by multiplying the ratio of the translational diffusion time of the component by the translational diffusion time of the reference material at the time of the performing of the fluorescence measurement of the sample containing the component, and therefore, in the measurement with a solution sample containing an arbitrary combination of arbitrary components, advantageously, there is no need to conduct the detections of translational diffusion times of the respective components every time. For example, supposing that the ratios of the translational diffusion times of components 1, 2 and 3 to the translational diffusion time of a reference material have been obtained, the existence ratio of each of the components in a solution sample containing the combination of components 1 and 2; the combination of components 1 and 3; the combination of components 2 and 3; or the combination of the components 1, 2, and 3 will be determined without repeating the detections of the translational diffusion time of each of components 1, 2 and 3.

The above mentioned inventive method is advantageously used for determining the liability of binding or dissociation and/or a binding constant or a dissociation constant of arbitrary plural molecules

1. A fluorescence correlation spectroscopic apparatus capable of detecting an existence ratio of each of components of at least two kinds with a fluorescent label contained in a solution sample, the apparatus comprising:
a data storage region which memorizes a value of a ratio of a translational diffusion time of each of the components of at least two kinds; and
a detecting portion that detects the existence ratio of each of the components of at least two kinds from an autocorrelation function value of a fluorescence intensity measured with the solution sample, using the memorized value of the ratio of the translational diffusion time of each of the components of at least two kinds.

2. The apparatus of claim 1,
wherein the value of the ratio of the translational diffusion time of each of the components of at least two kinds is a value of a ratio of the translational diffusion time of each of the components of at least two kinds to a translational diffusion time of a reference material with the fluorescent label.

3. The apparatus of claim 1, further comprising:
a portion that determining a translational diffusion time of each of the components of at least two kinds from an autocorrelation function value of a fluorescence intensity measured for each of the components of at least two kinds;
a portion that computes the value of the ratio of the translational diffusion time of each of the components of at least two kinds; and
a portion that memorizes in the data storage region the value of the ratio of the translational diffusion time of each of the components of at least two kinds.

4. The apparatus of claim 1, further comprising:
a portion that memorizes in the data storage region a predetermined value of the ratio of the translational diffusion time of each of the components of at least two kinds.

5. The apparatus of claim 1,
wherein the detecting portion detects the existence ratio of each of the components of at least two kinds from the autocorrelation function value of the fluorescence intensity measured with the solution sample containing the components of at least two kinds by fitting a theoretical formula of the autocorrelation function value, which formula includes as a parameter the value of the ratio of the translational diffusion time of each of the components of at least two kinds, to the autocorrelation function value of the fluorescence intensity measured with the solution sample containing the components of at least two kinds.

6. The apparatus of claim 5,
wherein a value obtained by multiplying a translational diffusion time of a reference material with the fluorescent label by the value of the ratio of the translational diffusion time of each of the components of at least two kinds is used as the translational diffusion time of each of the components of at least two kinds in the theoretical formula.

7. The apparatus of claim 5, further comprising
a portion that generates a warning that a precision in the fitting is insufficient when a chi square value in the fitting exceeds a predetermined threshold value.

8. The apparatus of claim 7,
wherein, as the predetermined threshold value, a different value can be set out for a different reference material.

9. A method for detecting an existence ratio of each of components of at least two kinds with a fluorescent label contained in a solution sample by fluorescence correlation spectroscopy, comprising:
(a) detecting the existence ratio of each of the components of at least two kinds from an autocorrelation function value of a fluorescence intensity measured with the solution sample, using a value of a ratio of a translational diffusion time of each of the components of at least two kinds memorized in a data storage region.

10. The method of claim 9,
wherein the value of the ratio of the translational diffusion time of each of the components of at least two kinds is a value of a ratio of the translational diffusion time of each of the components of at least two kinds to a translational diffusion time of a reference material with the fluorescent label.

11. The method of claim 9, further comprising:
(b) determining a translational diffusion time of each of the components of at least two kinds from an autocorrelation function value of a fluorescence intensity measured for each of the components of at least two kinds;
(c) computing a value of a ratio of the translational diffusion time of each of the components of at least two kinds; and
(d) memorizing in the data storage region the value of the ratio of the translational diffusion time of each of the components of at least two kinds.

12. The method of claim 9, further comprising:
(e) memorizing in the data storage region a predetermined value of the ratio of the translational diffusion time of each of the components of at least two kinds.

13. The method of claim 9,
wherein in step (a) the existence ratio of each of the components of at least two kinds from the autocorrelation function value of the fluorescence intensity measured with the solution sample containing the components of at least two kinds is detected by fitting a theoretical formula of the autocorrelation function value, which formula includes as a parameter the value of the ratio of the translational diffusion time of each of the components of at least two kinds, to the autocorrelation function value of the fluorescence intensity measured with the solution sample containing the components of at least two kinds.

14. The method of claim 13,
wherein a value obtained by multiplying a translational diffusion time of a reference material with the fluorescent label by the value of the ratio of the translational diffusion time of each of the components of at least two kinds is used as the translational diffusion time of each of the components of at least two kinds in the theoretical formula.

15. A computer program product having a computer readable medium including a program for detecting an existence ratio of each of components of at least two kinds with a fluorescent label contained in a solution sample by fluorescence correlation spectroscopy, wherein a program, when executed by a computer, makes the computer perform:
(a) detecting the existence ratio of each of the components of at least two kinds from an autocorrelation function value of a fluorescence intensity measured with the solution sample, using a value of a ratio of a translational diffusion time of each of the components of at least two kinds memorized in a data storage region.

16. The computer program product of claim 15,
wherein the value of the ratio of the translational diffusion time of each of the components of at least two kinds is a value of a ratio of the translational diffusion time of each of the components of at least two kinds to a translational diffusion time of a reference material with the fluorescent label.

17. The computer program product of claim 15, wherein the program further makes the computer perform:
(b) determining a translational diffusion time of each of the components of at least two kinds from an autocorrelation function value of a fluorescence intensity measured for each of the components of at least two kinds;
(c) computing the value of the ratio of the translational diffusion time of each of the components of at least two kinds; and
(d) memorizing in the data storage region the value of the ratio of the translational diffusion time of each of the components of at least two kinds.

18. The computer program product of claim 15, wherein the program further makes the computer perform:
(e) memorizing in the data storage region a predetermined value of the ratio of the translational diffusion time of each of the components of at least two kinds.

19. The computer program product of claim 15,
wherein, in (a), the existence ratio of each of the components of at least two kinds from the autocorrelation function value of the fluorescence intensity measured with the solution sample containing the components of at least two kinds is detected by fitting a theoretical formula of the autocorrelation function value, which formula includes as a parameter the value of the ratio of the translational diffusion time of each of the components of at least two kinds, to the autocorrelation function value of the fluorescence intensity measured with the solution sample containing the components of at least two kinds.

20. The computer program product of claim 19,
wherein a value obtained by multiplying a translational diffusion time of a reference material with the fluorescent label by the value of the ratio of the translational diffusion time of each of the components of at least two kinds is used as the translational diffusion time of each of the components of at least two kinds in the theoretical formula.

21. The computer program product of claim 19, wherein the program further makes the computer perform:
(f) generating a warning that a precision in the fitting is insufficient when a chi square value in the fitting exceeds a predetermined threshold value.
